(19) United States
(12) Patent Application Publication
(10) Pub. No.: US 2025/0141714 A1
(43) Pub. Date: May 1, 2025

(54) NETWORK-TO-NETWORK INTERCONNECTION TRANSFER

(71) Applicant: AT&T Intellectual Property I, L.P., Atlanta, GA (US)

(72) Inventors: Dongmei Wang, Basking Ridge, NJ (US); Wei Liao, Edison, NJ (US); Marco Platania, Maplewood, NJ (US); Vijay Gopalakrishnan, Edison, NJ (US); Slawomir Stawiarski, Carpentersville, IL (US); Jennifer Yates, Morristown, NJ (US)

(21) Appl. No.: 18/498,730

(22) Filed: Oct. 31, 2023

(51) Int. Cl. H04L 12/46; H04L 41/0896; H04L 41/5009

(52) U.S. Cl. CPC H04L 12/4641; H04L 41/0896; H04L 41/5012

(57) ABSTRACT

A processing system may identify first virtual circuits and first client systems associated with a first network-to-network interface between a first communication network and a second communication network, the first network-to-network interface having a first bandwidth parameter. The processing system may next select at least a first portion of the first client systems for transfer from the first virtual circuits associated with the first network-to-network interface to second virtual circuits associated with a second network-to-network interface between the first communication network and the second communication network, the second network-to-network interface having a second bandwidth parameter. The processing system may then generate an order to establish the second virtual circuits via the second network-to-network interface and transfer the at least the first portion of the first client systems to the second virtual circuits via the second network-to-network interface.

The present disclosure relates generally to communication network operations and network peering, and more specifically to methods, computer-readable media, and apparatuses for transferring a first plurality of client systems associated with at least a first network-to-network interface and a first plurality of virtual circuits to a second plurality of virtual circuits via at least a second network-to-network interface.

### BACKGROUND

A large communication network may lease thousands of Ethernet collectors. However, legacy collectors, e.g., with 1 Gb/s capacity, may be inefficient and more costly per unit bandwidth compared with newer 10 Gb/s Ethernet collectors. In many cases leasing a 10 Gb/s Ethernet collector is actually cheaper than a 1 Gb/s collector.

### SUMMARY

In one example, the present disclosure describes a method, computer-readable medium, and apparatus for transferring a first plurality of client systems associated with at least a first network-to-network interface and a first plurality of virtual circuits to a second plurality of virtual circuits via at least a second network-to-network interface. For instance, in one example, a processing system including at least one processor deployed in a first communication network may identify a first plurality of virtual circuits and a first plurality of client systems associated with at least a first network-to-network interface between the first communication network and at least a second communication network, the at least the first network-to-network interface having a first bandwidth parameter. The processing system may next select at least a first portion of the first plurality of client systems for transfer from the first plurality of virtual circuits associated with the at least the first network-to-network interface to a second plurality of virtual circuits associated with at least a second network-to-network interface between the first communication network and the at least the second communication network, the at least the second network-to-network interface having a second bandwidth parameter. The processing system may then generate an order to establish the second plurality of virtual circuits via the at least the second network-to-network interface and transfer the at least the first portion of the first plurality of client systems to the second plurality of virtual circuits via the at least the second network-to-network interface.

### BRIEF DESCRIPTION OF THE DRAWINGS

The present disclosure can be readily understood by considering the following detailed description in conjunction with the accompanying drawings, in which:

FIG. 1 illustrates one example of a system related to the present disclosure;

FIG. 2 illustrates an example architecture for edge service provider integration with a communication network in accordance with the present disclosure;

FIG. 3 illustrates a flowchart of an example method for transferring a first plurality of client systems associated with at least a first network-to-network interface and a first plurality of virtual circuits to a second plurality of virtual circuits via at least a second network-to-network interface, in accordance with the present disclosure; and

FIG. 4 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable storage media, and apparatuses for transferring a first plurality of client systems associated with at least a first network-to-network interface and a first plurality of virtual circuits to a second plurality of virtual circuits via at least a second network-to-network interface. In particular, examples of the present disclosure provide end-to-end automation for migrating client virtual circuits (e.g., Ethernet virtual circuits (EVCs)) across network-to-network Interfaces (NNI) established between a large communication network and one or more external access networks (e.g., 3^{rd} party access providers). For instance, a large network operator (e.g., a first network) may lease access circuits from 3^{rd} party access networks to enable network infrastructure of the first network to be connected to client locations where the first network does not have its own connectivity/presence. To illustrate, a large network operator may maintain thousands of Ethernet collectors (e.g., 1 Gb/s collectors), also referred to as NNIs, to connect client circuits through external/3^{rd} party access networks to a large communication network (e.g., a core network). However, these 1 Gb/s collectors provide substantially less bandwidth compared with newer Ethernet collectors (e.g., 10 Gb/s collectors). It may be a significant burden to maintain a large number of low-bandwidth collectors as compared to a lesser number of higher-bandwidth collectors. In addition, in many cases a 10 Gb/s Ethernet collector may even be less cost than a 1 Gb/s collector. Examples of the present disclosure provide for a process to reconfigure a network, migrating tens of thousands of client virtual circuits to higher bandwidth (e.g., 10 Gb/s) collectors and eliminating low-bandwidth (e.g., 1 Gb/s) collectors with minimal client/customer impact, powered by analytical and optimization algorithms for efficiency and service assurance.

Examples of the present disclosure may broadly comprise four steps to complete a migration for client virtual circuits terminating on a provider edge (PE) router via a network-to-network interface (NNI): (1) identifying candidate virtual circuit to migrate, (2) ordering new virtual circuits routed through the target collector and provisioning the virtual connectivity from the target NNI/collector to the same or a different PE, (3) migrating to new virtual circuits (and in some examples PE ports), and (4) disconnecting the old NNI/collector infrastructure. Notably, with thousands of collectors and tens of thousands of client virtual circuits it may be impossible to manually identify 1 Gb/s collectors for consolidation and to converge on a solution for rearranging the virtual circuits from the 1 Gb/s collectors to the 10 Gb/s collectors subject to a large set of complex optimization constraints. Migrating client virtual circuits to the target collector (step 3) is another challenge. For instance, in an existing process, transferring a single virtual circuit may take 45 minutes on the night of a cut. Therefore a technician may only be able to migrate two to three virtual circuits per night. However, a 1 Gb/s collector may have dozens to more than a hundred virtual circuits. Migrating all of the client virtual circuits off a 1 Gb/s collector may thus be a prolonged and inefficient process performed manually.

In one example, the present disclosure may operate based on the Open Network Automation Platform (ONAP) run-time Optimization Framework (OOF). In one example the present disclosure may comprise a planning process, or module, which may take the existing NNIs/collectors and client virtual circuits as input(s), may identify 1 Gb/s collectors which can be consolidated, and may generate a detailed virtual circuit migration plan (or plans). In one example, the present disclosure may also rank the opportunities based on the 1 Gb/s collector cost and the projected effort to migrate all of the client virtual circuits. An execution process may then prioritize the opportunities to achieve maximum benefit. In one example, the present disclosure may apply a daily (e.g., nightly) upgrade process. To maximize the number of virtual circuit migrated (and/or to maximize the number of 1 Gb/s collectors that are offloaded) nightly, the planning capability/module may attempt to migrate the client virtual circuits from the same 1 Gb/s collector to the same 10 Gb/s collector wherever possible, so the virtual circuits can be grouped together to be migrated by the same technician at the same time. In one example, on the night of a cut, in one click a technician can trigger the migration for all of the assigned virtual circuits. In one example, the ONAP may interwork with other network systems to parallelize the migration and monitor the progress, thereby allowing a technician to migrate dozens to hundreds of virtual circuits per night. This provides a significant improvement compared with the two to three virtual circuits that could previously be migrated per night.

In one example, a high-level framework architecture may provide a single user interface, available to a number of participants and different user groups to execute respective roles and responsibilities, including identifying migration opportunities, ordering new virtual circuits (or approving ordering of new virtual circuits in accordance with an auto-generated migration plan), and monitoring the status of virtual circuit orders through to completion of new virtual circuits over a target NNI/collector (or NNIs). In one example, an overall process may begin with a network inventory system updating ONAP with collector information and client virtual circuit information. In one example, this may auto-trigger an ONAP OOF-based planning module of the present disclosure to identify the NNI optimization opportunities. Once the design is ready, a project manager may review the opportunities and trigger the execution (or make changes). In one example, the ONAP OOF-based planning module may orchestrate and interwork with one or more other network systems to monitor the subsequent steps for all of the virtual circuits until the new virtual circuits are created. In one example, the planning module may also notify project managers to schedule a cutover (or cutovers) with a third party/external access network. Once the cutover is scheduled, ONAP may trigger the pre-configuration steps to prepare the circuits for a hot cut. On the night of a cut, the technician's role may be streamlined to trigger the migration of client virtual circuits to new virtual circuits routed over the target NNI/collector. In one example, this process may take approximately 5 minutes to execute. In one example, the present disclosure may also communicate with additional systems or processes via an interface created for tail migrations (a related ONAP-based automation). It should be noted that a tail may refer to the portion of the customer virtual circuit between the 3^{rd} party/external access network and the client systems (e.g., customer edge (CE) routers or the like).

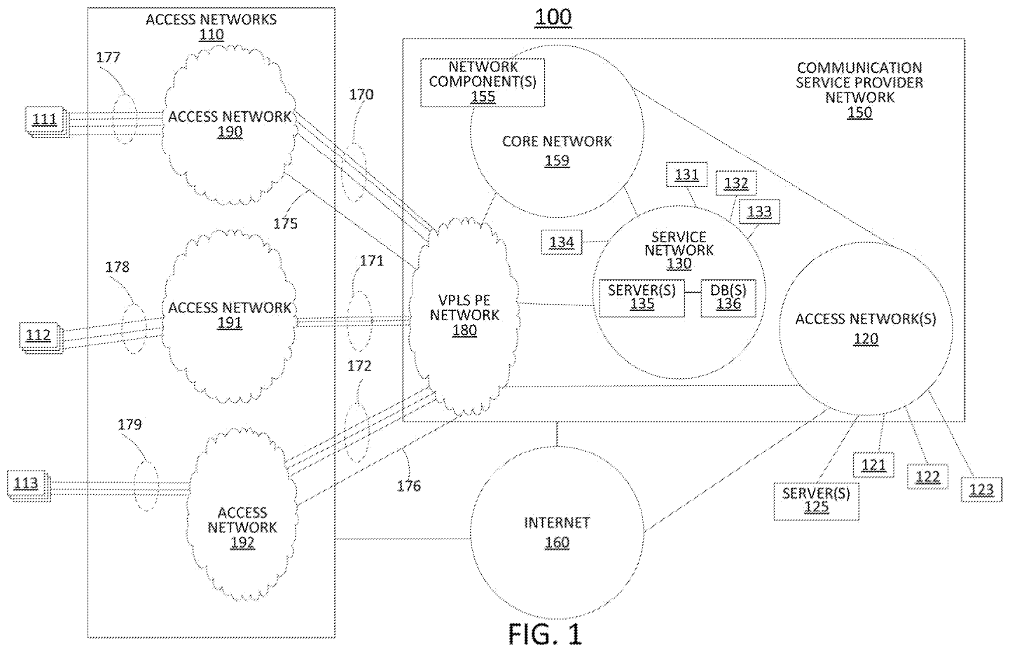

Thus, examples of the present disclosure may enable simultaneous, bulk virtual circuit migration. Notably, it has been demonstrated that for a 1 Gb/s collector, a 3^{rd} party/external network may establish new virtual circuits on a target collector (e.g., a 10 Gb/s collector) in less than 10 days, where the migration may be completed on the night of a cut in approximately 20 minutes, inclusive of time for the 3^{rd} party/external access network to verify the connection. These and other aspects of the present disclosure are discussed in greater detail below in connection with the examples of FIGS. 1-4.

To aid in understanding the present disclosure, FIG. 1 illustrates an example system 100 comprising a plurality of different networks in which examples of the present disclosure for may operate. Communication service provider network 150 may comprise a core network 159 with components for telephone services, Internet services, and/or video services (e.g., triple-play services, etc.) that are provided to customers (broadly “subscribers” or “clients”), and to peer networks. In one example, communication service provider network 150 may combine core network components of a cellular network with components of a triple-play service network. For example, communication service provider network 150 may functionally comprise a fixed-mobile convergence (FMC) network, e.g., an IP Multimedia Subsystem (IMS) network. In addition, communication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Communication service provider network 150 may also further comprise a broadcast television network, e.g., a traditional cable provider network or an Internet Protocol Television (IPTV) network, as well as an Internet Service Provider (ISP) network. With respect to video service provider functions, communication service provider network 150 may include one or more video servers (e.g., television servers) for the delivery of video content, e.g., a broadcast server, a cable head-end, a video-on-demand (VOD) server, and so forth. For example, communication service provider network 150 may comprise a video super hub office, a video hub office and/or a service office/central office.

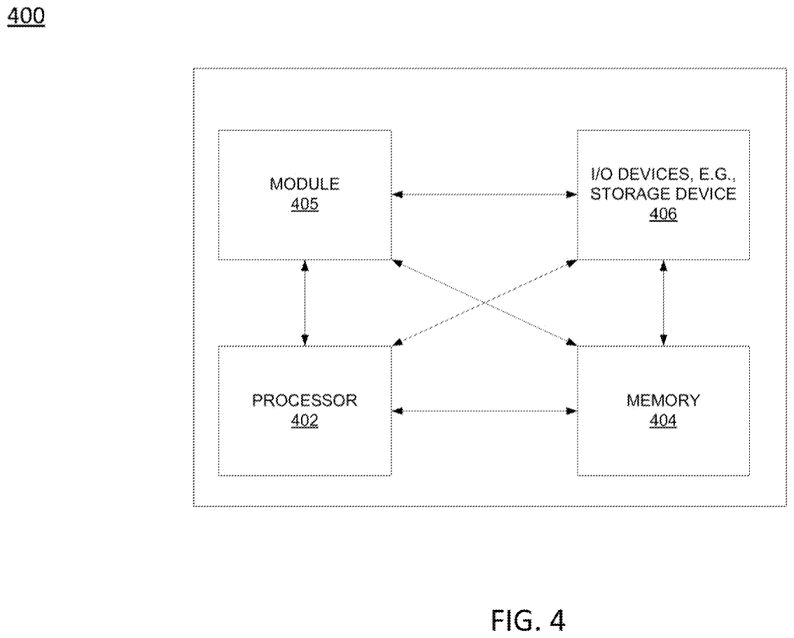

In one example, communication service provider network 150 may also include one or more network components 155. In one example, the network component(s) 155 may each comprise a computing system, such as computing system 400 depicted in FIG. 4, and may be configured to host one or more communication network components. For example, a first communication network component may comprise a database of assigned telephone numbers, a second communication network component may comprise a database of basic customer account information for all or a portion of the customers/subscribers of the communication service provider network 150, a third communication network component may comprise a cellular network service home location register (HLR), e.g., with current serving base station information of various subscribers, and so forth. Other communication network components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other communication network components may include, for example, a layer 3 router, a short message service (SMS) server, a voicemail server, a video-on-demand server, a server for network traffic analysis, a database server/database system, and so forth. It should be noted that in one example, a communication network component may be hosted on a single server, while in another example, a communication network component may be hosted on multiple servers, e.g., in a distributed manner. For ease of illustration, various other components of communication service provider network 150 and core network 159 thereof are omitted from FIG. 1.

In one example, various components of communication service provider network 150 comprise network function virtualization infrastructure (NFVI), e.g., software defined network (SDN) host devices (i.e., physical devices) configured to operate as various virtual network functions (VNFs), such as a Short Message Service (SMS) server, a voicemail server, a video-on-demand server, etc. For instance, network component(s) 155 may represent any one or more NFVI/SDN host devices configured to operate as any one or more of such VNFs. Similarly, in an example in which core network 159 may include a cellular core network (e.g., an evolved packet core (EPC), a 5G core or the like), network component(s) 155 may represent NFVI hosting one or more of a virtual MME (vMME), a virtual HHS (vHSS), a virtual serving gateway (vSGW), a virtual packet data network gateway (vPGW), and so forth. Thus, for example, network component(s) 155 may comprise a vMME, a vSGW, a virtual access management function (AMF), a virtual network slice selection function (NSSF), a virtual user plane function (UPF), and so forth,

Access networks 110 and 120 may transmit and receive communications between devices 111-113 and devices 121-123 among one another and/or with service network 130, and between communication service provider network 150 and devices 111-113 and 121-123 relating to voice telephone calls, communications with web servers via the Internet 160, and so forth. Access networks 110 and 120 may also transmit and receive communications between devices 111-113, 121-123, and other networks and devices via Internet 160. Devices 111-113 may each comprise customer premises equipment (CPE), which may include customer edge (CE) routers, gateways, servers (e.g., web servers, video and/or other content servers, conference servers, and so forth), a plurality or cluster of such devices, and so forth. Devices 111-113 may also include endpoint devices, e.g., mobile/wireless endpoint devices, such as a cellular smart phones, desktop, laptop, and/or tablet computers, televisions (TVs), e.g., a “smart” TV, set-top boxes (STBs), and so forth. Similarly devices 121-123 may each comprise customer premises equipment, e.g., CE routers, endpoint devices, etc. and/or endpoint devices.

In one example, access networks 120 may include a cellular access network (e.g., radio access network 195), implementing such technologies as: 3^{rd} Generation Partnership Project (3GPP) 5G new radio (NR) and/or Long Term Evolution (LTE) access technologies, global system for mobile communication (GSM), e.g., a base station subsystem (BSS), GSM enhanced data rates for global evolution (EDGE) radio access network (GERAN), or a UMTS terrestrial radio access network (UTRAN) network, among others, where core network 159 may provide cellular core network functions, e.g., of a public land mobile network (PLMN)-universal mobile telecommunications system (UMTS)/General Packet Radio Service (GPRS) core network, or the like. In this regard, access networks 120 may include one or more cell sites, which may include antenna arrays (e.g., remote radio heads (RRHs), base station equipment and/or one or more components thereof (e.g., a distributed unit (DU) and/or centralized unit (CU), etc.), transformers, battery units, and/or or other power equipment, and so forth.

In the example of FIG. 1, access networks 120 may also include a satellite access network, with a satellite and a ground station. For instance, a ground station may receive video content (e.g., from one or more video servers, such as network components 155) for uplink transmission. Accordingly, a satellite may receive video content from a ground station and may broadcast the video content to any of devices 121-123 (e.g., satellite communication-capable endpoint devices) within a coverage area of the satellite. In one example, a satellite access network may also convey other types of downlink and/or uplink data for any of devices 121-123 that are capable of receiving and/or transmitting via satellite access. As illustrated in FIG. 1, access networks 120 may be controlled and/or operated by a same network service provider as the communication service provider network 150. In another example, access networks 120 may be controlled and/or operated by a different entity and may carry video broadcast signals (and/or other communications) on behalf of communication service provider network 150. In one example, access networks 120 may alternatively or additionally provide wide area network (WAN) connectivity via a Digital Subscriber Line (DSL) network, a broadband cable access network, a fiber-optic access network, or the like (broadly, an internet service provider ISP) network).

In one example, access networks 110 (e.g., including at least access networks 190-192) may comprise 3^{rd} party networks that are operated by different entities from communication service provider network 150 (e.g., Internet service provider (ISP) networks). For instance, one or more of access networks 110 may comprise a wired access network, e.g., a Digital Subscriber Line (DSL) network, a broadband cable access network, a Local Area Network (LAN), a fiber-optic access network, a 3^{rd} party network, and so forth. For example, for a fiber-optic access network, the access network may include a mini-fiber node (MFN), a video-ready access device (VRAD) or the like. However, in another example, such an intermediate node may be omitted, e.g., for fiber-to-the-premises (FTTP) installations. In one example, devices 111-113 may be associated with customer premises networks, or client systems, e.g., a home network or enterprise network, which may include one or more gateways to receive data associated with different types of media, e.g., television, phone, and Internet, and to separate these communications for appropriate devices, one or more CE routers, and so forth. It should also be noted that in one example, access networks 110 and/or 120 may comprise “edge clouds” which may include host devices/nodes for providing cloud services in locations that may be physically closer to various endpoint devices that may utilize such services.

In one example, communication service provider network 150 may also include a virtual private local area network (LAN) service (VPLS) provider edge (VPLS-PE) network 180 that interconnects 3^{rd} party access networks 110 and other aspects of communication service provider network 150. In one example, VPLS-PE network 180 may also interconnect one or more access networks operated by a same entity as the communication service provider network 150 and/or sub-networks of the communication service provider network 150 with communication service provider network 150. For instance, one or more of access networks 120 may also support client virtual circuits via interconnection to VPLS PE network 180.

In one example, the service network 130 may comprise a local area network (LAN), or a distributed network connected through permanent virtual circuits (PVCs), virtual private networks (VPNs), and the like for providing data and voice communications. In one example, the service network 130 may be associated with the communication service provider network 150. For example, the service network 130 may comprise one or more devices for providing services to subscribers, customers, and/or users. For example, communication service provider network 150 may provide a cloud storage or other cloud computing service, web server hosting, and other services. As such, service network 130 may represent aspects of the communication service provider network 150 where infrastructure for supporting such services may be deployed. In another example, service network 130 may provide network management (e.g., including network upgrade planning and provisioning, network monitoring, including outage detection and monitoring, troubleshooting, remediation, etc.). In one example, service network 130 may include infrastructure supporting network management as-a-service to various other entities. For instance, in a managed information technology (IT) scenario, a network operator and client may enter into an agreement for proactive monitoring and support for managed assets (broadly, network elements).

In one example, communication service provider network 150 may provide virtual circuits (e.g., Ethernet virtual circuits (EVCs)) to clients/customers. In one example, these virtual circuits may be provisioned and managed by network component(s) 155. Alternatively, or in addition, these virtual circuits may be provisioned and managed by server(s) 135. In the example of FIG. 1, at least some of these virtual circuits may traverse 3^{rd} party access networks 110 (e.g., including at least access networks 190-191). For instance, a client associated with one of the devices 111 may have a virtual circuit provisioned via 3^{rd} party access network 190 to communication service provider network 150. To support client virtual circuits via 3^{rd} party access networks 110, communication service provider network 150 may include an associated provider edge network (e.g., VPLS-PE network 180).

In one example, the service network 130 links one or more devices 131-134 with each other and with Internet 160, other aspects of communication service provider network 150, devices accessible via such other networks, such as devices 111-113 and 121-123, and so forth. In one example, devices 131-134 may each comprise a telephone for analog or digital telephony, a mobile device, a cellular smart phone, a laptop, a tablet computer, a desktop computer, a bank or cluster of such devices, and the like. In an example where the service network 130 is associated with the communication service provider network 150, devices 131-134 of the service network 130 may comprise devices of network personnel, such as network operations personnel and/or personnel for network maintenance, network repair, construction planning, customer service, and so forth.

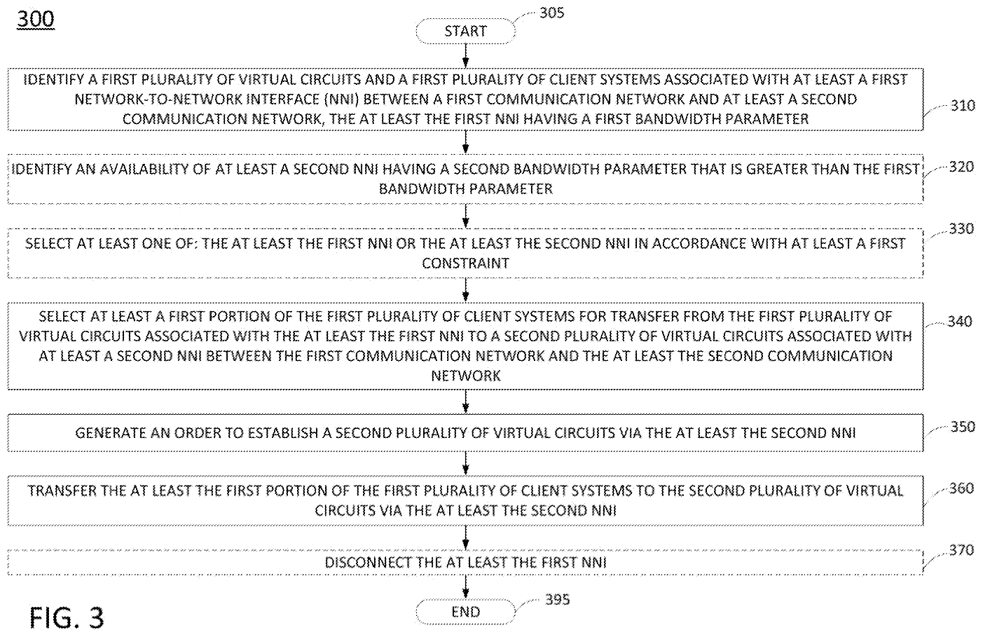

In the example of FIG. 1, service network 130 may include one or more servers 135 which may each comprise all or a portion of a computing device or system, such as computing system 400, and/or processing system 402 as described in connection with FIG. 4 below, specifically configured to perform various steps, functions, and/or operations in connection with examples of the present disclosure for transferring a first plurality of client systems associated with at least a first network-to-network interface and a first plurality of virtual circuits to a second plurality of virtual circuits via at least a second network-to-network interface. For example, one of the server(s) 135, or a plurality of the servers 135 collectively, may perform operations in connection with the example method 300 of FIG. 3, or as otherwise described herein. For instance, the one or more servers 135 may represent an open network automation platform (ONAP), or the like.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, service network 130 may also include one or more databases (DBs) 136, e.g., physical storage devices integrated with server(s) 135 (e.g., database servers), attached or coupled to the server(s) 135, and/or in remote communication with server(s) 135 to store various types of information in support of systems for transferring a first plurality of client systems associated with at least a first network-to-network interface and a first plurality of virtual circuits to a second plurality of virtual circuits via at least a second network-to-network interface, as described herein. As just one example, DB(s) 136 may store an inventory, or inventories of NNIs/collectors (e.g., 1 Gb/s collectors and 10 GB/s collectors), with information such as (for each collector): collector location information, collector sub-net information, the ports used, the ports available, the device type (e.g., manufacturer, model, etc.), device age, last serviced date, virtual circuits supported by the collector, an occupied/assigned capacity, an available capacity, a software version, and other features. Likewise DB(s) 136 may store an inventory of client virtual circuits with information such as (for each virtual circuit): a client identifier, client account information or a link and/or pointer to client account information in another database, location information of the virtual circuit, the NNI/collector to which the virtual circuit is assigned, an access network associated with the virtual circuit (which in some examples may comprise a 3^{rd} party access network), a particular type or characteristic of the virtual circuit, such as whether the virtual circuit is a port-based service or a virtual local area network (VLAN)-based service, for a VLAN-based service, whether the virtual circuit is dual-/multi-tagged/labeled, whether the virtual circuit is an iVLAN circuit (e.g., the virtual circuit has a public IP address), whether the virtual circuit is associated with a fine-grained card (FGC) or a coarse-grained card (CGC), whether the virtual circuit is associated with a particular service class (e.g., managed internet services (MIS) (e.g., provided by communication service provider network 150 to the client)) and/or carrier-supported virtual private network (VPN)) and so forth.

In one example, the inventory of client virtual circuits and/or a different data set may include client constraints for one or more clients, e.g., relating to which collectors the client virtual circuit(s) may be assigned. For instance, the constraints may include geographic constraints, security constraints (e.g., a preferred encryption protocol, available encryption protocols, etc., a constraint indicating that a particular client virtual circuit is not to share infrastructure with virtual circuit for other clients that may cross national borders, etc.), a constraint that a client virtual circuit is not to be rehomed to a different PE router, a constraint that a client virtual circuit is not to be assigned to a collector that has more than 90 percent occupancy, and so forth.

In addition, DB(s) 136 may receive, create, and/or store records relating to equipment of VPLS PE network 180, such as various provider edge (PE) routers and/or edge gateway servers (e.g., each comprising a point of presence (POP)). For example, DB(s) 136 may maintain an inventory of each device in VPLS-PE network 180, which may include for each record: device characteristics (e.g., device type, manufacturer, make, model, version, serial number, etc., a number of available line cards, the type(s) of available line cards, and so forth), identifiers of network-to-network interfaces (NNIs) assigned to the device, the ports assigned/utilized, identifiers of the access networks associated with the NNIs (e.g., if not contained in the NNI identifiers), the NNI characteristics (e.g., 1 Gb/s or 10 Gb/s, etc.), identifiers of corresponding client virtual circuits assigned to particular NNIs, a resource occupancy and/or availability (e.g., a new POP may have 100% capacity before any client virtual circuits are assigned thereto), and so forth. Alternatively, or in addition, each record may include one or more links to information regarding NNIs associated with a particular POP (e.g., links to corresponding records in an NNI/collector inventory), and so on.

In accordance with the present disclosure, DB(s) 136 may further store various constraints associated with client virtual circuit migrations. For instance, example client constraints are mentioned above. In addition, DB(s) 136 may store service constraints, provider-specific constraints, and/or network constraints, e.g., various rules associated with client virtual circuits. For instance, service constraints may define in-scope services (e.g., communication service provider network 150 may provide various services associated with client virtual circuits, such as virtual private network (VPN), managed internet services (MIS), iVLAN (e.g., VLAN with public facing IP address), and so forth). This constraint may thus define which services are to be considered for client virtual circuit migration and which may be omitted. Another service constraint may include whether IP address preservation is to be provided. For instance, for MIS and VPN with iVLAN, IP address preservation may be implemented. For other services, a client virtual circuit migration may allow for the IP addresses of client systems (e.g., CPEs) to change. Still another service constraint may relate to class of service (CoS) hierarchy. For instance, certain services may be associated with a CoS scheme with a particular number of classes (e.g., 0 to 9, 1 to 9, or the like), while other services may be associated with a different class of service scheme with more or less classes (e.g., classes 0-5, 1-5, or the like). Still another service constraint may define the particular set of services to be included in formulating a migration plan, e.g., all edge service provider shared Ethernet services, or the like. For instance, this constraint may define an initial scope of formulating a migration plan for client virtual circuits.

Provider-specific constraints may include one or more constraints, e.g., rules, associated with particular access network providers, such as a rule defining that port-based and VLAN-based services may not be mixed on the same collector, a rule defining that optical Ethernet wide area network (OPT-E-WAN) services and optical Ethernet metropolitan area network (OPT-E-MAN) may not be placed on the same collector, and so forth. These rules may be defined by/for particular 3^{rd} party access networks/providers and may therefore be applicable to respective client virtual circuits associated with respective access networks. In one example, these constraints may be obtained from one or more of access networks 110. In addition, network constraints may include constraints/rules relating to network availability, such as an edge equipment lock status. For instance, a lock status may indicate that an edge gateway and/or provide edge router may be unavailable for assignment of new client virtual circuits and/or for reassignment/transfer-in of existing client virtual circuits. For example, the edge equipment may be full/at capacity, may be designated for certain types of client virtual circuits (e.g., for first responder and/or governmental client systems only, or the like), and so forth. Another network constraint may comprise a PE rehoming constraint associated with a network routing protocol (e.g., Border Gateway Protocol (BGP), or the like).

Similarly, an example device constraint may include a target NNI equipment model, or models (e.g., for PoPs). Related thereto, the constraints may also include one or more resource constraints. For example, a first resource constraint may define a maximum NNI bandwidth utilization (e.g., 75%, 80%, etc.). Thus, for example, this constraint may be considered in conjunction with a device constraint defining a target equipment model (which may have a designated maximum bandwidth, and other maximum performance characteristics). Another example resource constraint may comprise a VLAN tag availability constraint. For instance, such a constraint/rule may define that there are to be no duplicated VLAN tags on the same target NNI. Still another example resource constraint may comprise a constraint that restricts VLAN tag reassignment to dual-tagged, or multi-tagged VLAN-based services and port-based services. For instance, with dual tags, an outer tag can be reassigned by a network operator, while client system operations may be undisrupted with an inner tag remaining unchanged. It should be noted that the foregoing are provided as examples, and that other, further, and different constraints may be applicable as defined by a network operator of communication service provider network 150, as defined by one or more of the 3^{rd} party access networks 110, as defined by one or more clients associated with devices 111-113, as may arise due to the particular network equipment in use, and so forth.

In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like. In this regard, server(s) 135 and/or DB(s) 136 may maintain communications with one or more of the devices 111-113 and/or devices 121-123 via access networks 110 and 120, communication service provider network 150, Internet 160, and so forth, e.g., in order to collect, maintain, and/or update wireless network inventory information, wireless network performance information, etc. and to communicate such information to various endpoint devices for establishing a communication session for a first process in operation on an endpoint device via a first wireless access network that is selected based upon performance information of a plurality of wireless access networks.

As noted above, server(s) 135 may be individually or collectively configured to perform operations for transferring a first plurality of client systems associated with at least a first network-to-network interface and a first plurality of virtual circuits to a second plurality of virtual circuits via at least a second network-to-network interface, e.g., in accordance with the example method 300 of FIG. 3, or as otherwise described herein. To illustrate, server(s) 135 may identify a first plurality of virtual circuits and a first plurality of client systems associated with at least a first network-to-network interface (NNI) between communication service provider network 150 and one or more of access networks 110, where the at least the first NNI may have at least a first bandwidth parameter (e.g., 1 Gb/s or the like). For example, server(s) 135 may identify any one or more of NNIs 170-172. It should be noted that NNIs 170 may represent a plurality of NNIs having the first bandwidth parameter. In addition, each of NNIs 170 may have one or a plurality of client virtual circuits assigned thereto, e.g., client virtual circuits associated with any one or more of devices 111 (e.g., client systems) via access network 190, and similarly for NNIs 171 and client virtual circuits associated with devices 112 via access network 191, NNIs 172 for client virtual circuits associated with devices 113 via access network 192, and so forth. In this regard, FIG. 1 further illustrates “tail circuits” 177-179, which may comprise portions of, or which may be included in paths for respective client virtual circuits. Each of the tail circuits 177-179 may also be referred to as a subscriber line access, local tail, local loop, or “last mile.” In the example of FIG. 1, server(s) 135 may identify the plurality of virtual circuits by accessing an inventory of client virtual circuits from DB(s) 136 as described above.

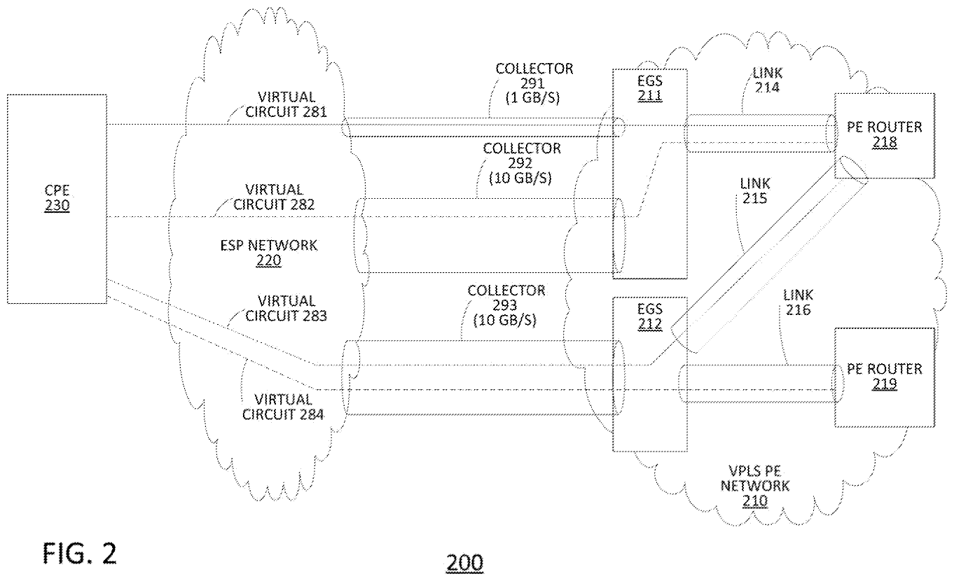

Server(s) 135 may then select at least a first portion of the first plurality of client systems for transfer from the first plurality of virtual circuits associated with the at least the first NNI (e.g., any one or more of NNIs 170-172) to a second plurality of virtual circuits associated with at least a second NNI between the between communication service provider network 150 and one or more of the access networks 110. For instance, the at least the second NNI may have at least a second bandwidth parameter, e.g., that is larger than the at least the first bandwidth parameter (such as 10 Gb/s or the like). In one example, server(s) 135 may similarly identify the at least the second NNI by accessing the NNI/collector inventory (or one of a plurality of inventories of NNIs/collectors, or the like) from DB(s) 136. For example, server(s) 135 may identify an availability of NNIs 175 and 176. As described in greater detail below, server(s) 135 may next generate an order to establish the second plurality of virtual circuits via the at least the second NNI, e.g., in accordance with various constraints/rules maintained by server(s) 135 (e.g., stored in DB(s) 136). Server(s) 135 may then transfer the first plurality of client systems to the second plurality of virtual circuits via the at least the second NNI. This may include communications to one or more of the access networks 110 to secure changes within the respective access networks 110 to support the new client virtual circuits (e.g., potential upgrades or other changes to tail circuits 177-179, etc.), outputting a plan and/or generating instructions for network personnel to initiate transfer/changes (e.g., to one or more of devices 131-134), generating one or more sets of instructions to automatically execute a transfer of client systems to new virtual circuits (which may be similarly characterized and transferring of client virtual circuits to new collectors/NNIs), disconnecting the at least the first NNI, e.g., including deactivating the first plurality of virtual circuits, and other operations. Additional or alternative aspects of transferring a first plurality of client systems associated with at least a first network-to-network interface and a first plurality of virtual circuits to a second plurality of virtual circuits via at least a second network-to-network interface are described in greater detail below in connection with the examples of FIGS. 2 and 3.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of server(s) 135 and DB(s) 136 may be distributed at different locations, such as in or connected to access networks 120, in another service network connected to Internet 160 (e.g., a cloud computing provider), in communication service provider network 150, and so forth. Thus, these and other modifications are all contemplated within the scope of the present disclosure.

FIG. 2 illustrates an example architecture 200 for edge service provider integration with a communication network in accordance with the present disclosure. For example, a communication network including VPLS PE network 210 may provide virtual circuits (e.g., an EVC service) to various clients, at least some of which may not have access network connectivity (e.g., tail/last mile service) available from the same network operator. For instance, as illustrated in FIG. 2, a client having customer premises equipment (CPE) 230 (e.g., a client system) may obtain wide area network (WAN) access via an edge service provider (ESP) network 220. Continuing with the present example, CPE 230 may have a virtual circuit 281 established by the network operator via ESP network 220, which interconnects to the communication network via VPLS PE network 210. To further illustrate, virtual circuit 281 may be assigned to a network-to-network interface (NNI)/collector 291 (e.g., a 1 Gb/s collector) that interconnects ESP network 220 with VPLS PE network 210 via a first edge gateway server (EGS) 211.

As described above, the network operator may seek to improve these virtual circuits and related services by transferring the client virtual circuits from 1 Gb/s collectors to 10 Gb/s collectors (or the like). In the example of FIG. 2, there are two options for transferring virtual circuit 281 (e.g., establishing new virtual circuit via a 10 Gb/s collector and reassigning CPE 230 thereto): collector 292 and collector 293. Notably, collector 292 may interconnect ESP network 220 with the same EGS 211 as the collector 291. However, collector 293 may interconnect ESP network 220 with VPLS PE network 210 via a different EGS 212. Notably, across the entire communication network there may be thousands of 1 Gb/s collectors, each of which may host from one to 100 virtual circuits. In accordance with the present disclosure, migrating client virtual circuits to larger collectors, such as collectors 292 and 293, is not straightforward, and may involve the implementation of various constraints. For instance, client virtual circuit 281 may have a particular VLAN tag/label. One candidate for migration is virtual circuit 282 (e.g., transferring CPE 230 to virtual circuit 282, and disabling virtual circuit 281). However, if the same VLAN tag/label is already in use by another virtual circuit via collector 292, then a VLAN tag collision may occur. In such case, virtual circuit 282 may not be a viable candidate for migrating virtual circuit 281.

Alternatively, or in addition, virtual circuit 281 and/or CPE 230 may have an associated constraint of “no PE rehoming.” Thus, for example, while virtual circuit 284 (via collector 293 and link 216 connecting to PE router 219) may be a valid path for another virtual circuit, this may also be non-viable for the transfer of virtual circuit 281 and/or migration of CPE 230 to a new virtual circuit. However, in the example of FIG. 2, VPLS PE network 210 may include a link 215 between EGS 212 and PE router 218. As such, virtual circuit 283 may be considered for the transfer of virtual circuit 281 and/or migration of CPE 230 to a new virtual circuit.

In a more complete procedure, a processing system of the present disclosure, such as server(s) 135 (e.g., a virtual circuit migration platform), may identify candidate virtual circuits to migrate, may order new NNI/collectors and may provision connectivity, may migrate client virtual circuits to the new NNIs/collectors (including migrating PE ports), and may then disconnect the old NNI infrastructure. The identification of candidate client virtual circuits, the provisioning of connectivity, and the migration of the client virtual circuits may be in accordance with a set of rules/constraints, e.g., implemented via an automated algorithm or program. In one example, a virtual circuit migration platform (e.g., ONAP or a component thereof) may include two modules, e.g., a decision maker module and a planner module. For instance, the planner module may identify candidate virtual circuits for migration and may generate recommendations for new 10 Gb/s collectors based on bandwidth needs or other factors associated with the candidate virtual circuits. Alternatively, or in addition, the planner module may recommend a new edge gateway server (such as EGS 212) based on one or more constraints identified for use in generating recommendations via the planning module (e.g., PE rehoming constraint and VLAN collision constraint), may recommend a number of new 10 Gb/s NNIs with fine grained card or coarse grained card based on network constraints, and so forth.

In one example, a decision making module may implement the same or different constraints (e.g., network constraints, bandwidth constraints, a VLAN tag constraint, a PE rehoming constraint, etc.), to fulfill one or more optimization objectives, such as: minimize PE rehoming and/or VLAN collisions, maximize cost saving, minimize a number of new NNIs/collectors needed, maximize utilization of existing 10 Gb/s NNIs/collectors, etc. It should be noted that both the planning module and the decision maker module may implement heuristic-based optimization using these or other constraints, and may further consider the type(s) service, the availability of existing 10 Gb/s NNIs or other network infrastructures, the availability of network personnel, and so forth. In one example, additional constraints may be added (or removed) as migration proceeds. In one example, the decision maker model may generate detailed virtual circuit migration plan, e.g., projecting one or several days. However, in one example, the plan may be re-evaluated (e.g., daily) to account for any changes in the network. In one example, the plan may include a set of automated instructions which may be initiated by the network (or by network personnel) to initiate a bulk migration, e.g., of client virtual circuits off of an existing low bandwidth collector to a high bandwidth collector. For instance, in one example, an objective may be to completely offload a low bandwidth collector in a single session (e.g., within the same day and initiated via the same instructions). If a collector cannot be completely offloaded as a package (e.g., such as where one or more virtual circuits cannot be migrated to a new collector along with others due to a VLAN tag collision, a PE rehoming constraint, or the like), in one example the offloading of the collector may be de-prioritized. For instance, one or more other collectors may be preferentially scheduled for offloading for a next day/evening. Alternatively, or in addition, if an alternative collector can be identified and is available for one or more client virtual circuits that cannot be migrated to a same new collector along with the rest of the virtual circuits to be offloaded from an old collector, then the offloading of the old collector may be scheduled, e.g., where migration instructions may include the transfer of one or more virtual circuits to one or more other collectors.

In one example, planning recommendations from the planning module may result in the deployment of new collectors or other network infrastructures. These updates may then affect whether and when the decision making module may actually schedule and provide instructions for a cut-over. Similarly, the planning module may recommend changes that may be communicated to 3^{rd} party access networks. The 3^{rd} party access networks may implement complementary updates within the respective access networks prior to virtual circuit migration/transfer to new collectors. In addition, in one example, the virtual circuit migration platform may obtain information from 3^{rd} party access networks indicating when new tail circuits or other changes to support client virtual circuit migration are complete. Thus, the actual scheduling of changes can be scheduled by the decision making module when it is confirmed that supporting infrastructure from either or both of the host communication network side and the access network side is in place.

It should be noted that the example of FIG. 2 is provided for illustrative purposes and that other, further, and different configurations may exist in accordance with the present disclosure. As just one example, although FIG. 2 illustrates PE routers 218 and 219, these components may include switches, hubs, or the like, such as packet optical switches/platforms, etc. In addition, a single virtual circuit and only three migration options (e.g., virtual circuits 282-284) are illustrated in FIG. 2. However, there may be more or less viable options within a different example, such as for a different geographic region, a different network zone, a different client with different constraints, and so on. Thus, these and other modifications are all contemplated within the scope of the present disclosure.

FIG. 3 illustrates a flowchart of an example method 300 for transferring a first plurality of client systems associated with at least a first network-to-network interface and a first plurality of virtual circuits to a second plurality of virtual circuits via at least a second network-to-network interface. In one example, steps, functions, and/or operations of the method 300 may be performed by a device as illustrated in FIG. 1, e.g., server(s) 135, or the like, servers(s) 135 in conjunction with one or more other devices or systems, such as DB(s) 136, network component(s) 155, access networks 110, and so forth. In one example, the steps, functions, or operations of method 300 may be performed by a computing device or system 400, and/or a processing system 402 as described in connection with FIG. 4 below. For instance, the computing device 400 may represent at least a portion of a dual/multi-modality wireless endpoint device, in accordance with the present disclosure. For illustrative purposes, the method 300 is described in greater detail below in connection with an example performed by a processing system. The method 300 begins in step 305 and proceeds to step 310.

At step 310, the processing system identifies a first plurality of virtual circuits and a first plurality of client systems associated with at least a first network-to-network interface (NNI)/collector between a first communication network and at least a second communication network, the at least the first NNI having a first bandwidth parameter (e.g., a nominal capacity and/or throughput of 1 Gb/s or the like).

At optional step 320, the processing system may identify an availability of at least a second NNI. For instance, in one example, the identifying of the availability of the at least the second NNI may follow the identifying of the first plurality of virtual circuits and the first plurality of client systems, which may be candidates for offloading from the at least the first NNI. The at least the second NNI may be selected from among a plurality of NNIs having a second bandwidth parameter that is different from the first bandwidth parameter (e.g., where the second bandwidth parameter is greater than the first bandwidth parameter). For instance, the at least the first NNI may comprise a 1 gigabit interface (e.g. 1 Gb/s) and the at least the second NNI may comprise a 10 gigabit interface (e.g., 10 Gb/s).

At optional step 330, the processing system may select at least one of: the at least the first NNI or the at least the second NNI in accordance with at least a first constraint. In one example, the at least the first NNI may be selected in response to the identifying of the availability of the at least the second NNI. For instance, in one example, the availability of a new NNI/collector (e.g., with the second bandwidth parameter) may trigger a reevaluation of client virtual circuits for transfer from one or more existing NNIs (e.g., having the first bandwidth parameter) to the new NNI having the second bandwidth parameter (e.g., a having a greater capacity for supporting a larger number of virtual circuits). As discussed above, the at least the first constraint may comprise at least one of: at least one network constraint, at least one bandwidth constraint, at least one VLAN tag constraint, at least one provider edge rehoming constraint, or the like.

For instance, the at least one provider edge rehoming constraint may comprise a constraint specifying that the at least the first NNI terminates on a same provider edge (PE) router as the at least the second NNI. Similarly, the at least one bandwidth constraint may comprise a constraint specifying that the at least the second NNI has an available bandwidth that exceeds an aggregate bandwidth demand of the first plurality of virtual circuits. The at least one network constraint (or provider constraint) may comprise a constraint obtained from the at least the second communication network. For instance, the at least one network constraint may comprise a constraint specifying that the at least the second NNI does not service virtual circuits of different types. In addition, the at least one VLAN tag constraint may comprise a constraint that first VLAN tags associated with the first plurality of virtual circuits are unique with respect to second VLAN tags associated with a second plurality of virtual circuits assigned to the at least the second NNI. In one example, the at least one VLAN tag constraint may alternatively or additionally comprise a constraint that VLAN tags of the first VLAN tags that are non-unique with respect to the second VLAN tags are for dual-tagged virtual circuits of the first plurality of virtual circuits. For instance, as described above, these client virtual circuits may be rehomed if outer tag(s) is/are used for network-based routing, where the inner tag(s) may remain unchanged such that client systems do not need to be reconfigured to use a new tag, or tags. It should be noted that one or more constraints may be found in different categories. For instance, one or more network constraints or provider constraints may be the same as or overlap with one or more client constraints.

In one example, optional step 330 may include selecting of the at least one of the at least the first NNI or the at least the second NNI in accordance with at least a first constraint and based on a priority of association between the at least the first NNI and the at least the second NNI. For instance, the priority of association may be a score for a pairing of the first NNI with the second NNI. To illustrate, the priority of association may be based on at least one of: a number of managed information technology clients of the first plurality of client systems, a number of tag collisions of the first plurality of virtual circuits on the second NNI (e.g., client tag collisions, where this metric may exclude tag collisions for dual-tag VLANs where a network operator tag can be relabeled without affecting client configurations), a number of NNIs of the at least the second NNI to be used to transfer the first plurality of virtual circuits (for instance, using fewer target NNIs may be preferred; offloading of client virtual circuits from old NNIs having the first bandwidth parameter where multiple new NNIs are required may be deprioritized), a number of virtual circuits of the first plurality of virtual circuits that are not able to be transferred off of the at least the first NNI without a provider edge (PE) rehoming (e.g., this circumstance may also be avoided or deprioritized if no NNI having a larger bandwidth parameter can be found that can accommodate all client virtual circuits of the at least the first NNI to be offloaded).

To further illustrate, the selection may be based on the priority of association, where the priority may be based on at least one objective function, such as: a highest level of compliance, a count of a number of MIS clients, a least number of circuits that fail a compliance with a constraint, or a function based on a composite of factors. For example, the priority of association of the at least the first NNI and the at least the second NNI may be based on a minimization of VLAN tag collisions (which in one example may include identifying alternate NNIs that can take circuit(s) with a tag collision). Alternatively, or in addition, the priority of association may be based on a number of virtual circuits that cannot be transferred from a first NNI to a same new NNI (e.g., the second NNI). For instance, the processing system may minimize the number of virtual circuits that cannot be transferred in bulk/as a set. Similarly, in one example the priority of association may be based on a minimization of the number of new NNIs for transferring all client virtual circuits of the first NNI. For instance, comparing 1 Gb/s NNIs to be offloaded, a first 1 Gb/s NNI that can be offloaded with a fewer number of new 10 Gb/s NNIs may be selected with higher priority than a second 1 Gb/s NNI that can be offloaded only using a larger number of 10 Gb/s NNIs. In still another example, the processing system may prioritize the first NNI over others based on eliminating or minimizing the number of virtual circuits that cannot presently be transferred (as compared to the best result achievable for other 1 Gb/s NNIs). In a similar manner, the processing system may prioritize the first NNI (1 Gb/s) in association with the second NNI (10 Gb/s) to which virtual circuits may be transferred, compared to the result for the same first NNI (1 Gb/s) to other 10 Gb/s NNIs (e.g., in view of the number of virtual circuits that cannot be transferred as a result of client VLAN tag collisions that cannot be addressed by relabeling, PE rehoming constraint violations, or the like).

In various examples, the selection may be in accordance with a selection function comprising an artificial intelligence (AI) and/or a machine learning (ML) algorithm (MLA), e.g., a decision tree, a binary classifier, etc. For instance, a selection function may generate a score for each available pairing from among which a pairing with a highest score, a lowest score, the lowest absolute value, etc. may be selected for migration (e.g., in a next day/evening migration plan). In one example, factors such as described above may comprise an input vector to the selection logic, in response to which the selection logic may generate an output (e.g., the score(s) for the available pairings(s)). In one example, a machine learning model (MLM), e.g., a trained MLA, may be trained to learn weights to apply to respective input factors of an objective function. For instance, the MLM may generate recommendations for NNI offloading (e.g., pairs of low bandwidth NNIs and the high bandwidth NNIs to which to offload the low bandwidth NNIs). In one example, network personnel may then permit offloading/migration to proceed according to the recommendations, or may make changes to the recommendations/plan. As such, this feedback may be used to adjust the factor weighting and adapt the recommendations based upon labeling/feedback (e.g., in a reinforcement learning (RL) framework).

It should be noted that as referred to herein, a machine learning model (MLM) (or machine learning-based model) may comprise a machine learning algorithm (MLA) that has been “trained” or configured in accordance with input training data to perform a particular service. For instance, an MLM may comprise a deep learning neural network, or deep neural network (DNN), a convolutional neural network (CNN), a generative adversarial network (GAN), a decision tree algorithm/model, such as gradient boosted decision tree (GBDT) (e.g., XGBoost, XGBR, or the like), a support vector machine (SVM), e.g., a non-binary, or multi-class classifier, a linear or non-linear classifier, k-means clustering and/or k-nearest neighbor (KNN) predictive models, and so forth. It should be noted that various other types of MLAs and/or MLMs, may be implemented in examples of the present disclosure.

At step 340, the processing system selects at least a first portion of the first plurality of client systems for transfer from the first plurality of virtual circuits associated with the at least the first NNI to a second plurality of virtual circuits associated with at least a second NNI between the first communication network and the at least the second communication network, the at least the second NNI having a second bandwidth parameter. In one example, the selecting may include identifying the at least the first portion as complying with at least one constraint. For instance, the at least one constraint may include one or more of: at least one network constraint, at least one bandwidth constraint, at least one virtual local area network tag constraint, at least one provider edge rehoming constraint, etc. For example, these constraints may be of a same or similar nature as the constraints described above in connection with optional step 330. It should be noted that at least a second portion of the first plurality of clients systems (e.g., those not selected at step 340) may comprise at least one client system having at least one virtual circuit of the first plurality of virtual circuits that does not comply with the at least one constraint.

In one example, aspects of step 340 may be the same or similar to operations of optional step 330 described above. For instance, optional step 330 may identify which low bandwidth NNIs should be prioritized for offloading, based upon the anticipated ability to more fully offload the NNI in bulk to a same target NNI, to minimize VLAN tag collisions and/or PE rehoming in consideration of an available target NNI, etc. However, step 340 may then identify the actual virtual circuits and client systems of the at least the first NNI that are to be transferred to the second NNI. In one example, step 340 may further include selecting at least a second portion of the first plurality of client systems for transfer from the first plurality of virtual circuits associated with the at least the first NNI to a third plurality of virtual circuits associated with at least a third NNI between the first communication network and the at least the second communication network (e.g., the at least the third NNI having the second bandwidth parameter). For example, virtual circuits of the first plurality of client systems that cannot be offloaded to the second NNI (for reasons such as described above, e.g., VLAN tag collision, PE rehoming, etc.) may be transferred to one or more other NNIs. In various examples, the selection may be in accordance with a selection function comprising an AI and/or ML model. For instance, a selection function may output recommended assignments of client systems/virtual circuits to new NNIs. In one example, network personnel may then permit offloading/migration to proceed according to the recommendations, or may make changes to the recommendations/plan. As such, this feedback may be used to for MLM training and/or updating to adapt the recommendations based upon labeling/feedback.

At step 350, the processing system generates an order to establish the second plurality of virtual circuits via the at least the second NNI. For instance, the order may include a set of instructions generated based upon the selection(s) of step 340, which may include instructions for PE routers, PoPs, EGSs, or the like for line card and port configuration, forwarding tables, etc. to support new client virtual circuits. In one example, the order may further include an order, request, and/or instructions for the second communication network to update any infrastructures of the second communication network to support the second plurality of virtual circuits, e.g., any updates of the edge service provider network, including tail/local loop changes. In one example, the order may further include a request for deployment of new physical infrastructures in the first communication network to support the second plurality of virtual circuits (e.g., a network provisioning order for the at least the second NNI, POP(s), PE router(s), packet optical switching platforms, etc.). In one example, the order may schedule a migration of the at least the first portion of the first plurality of client systems to the second plurality of virtual circuits via the at least the second NNI.

At step 360, the processing system transfers the at least the first portion of the first plurality of client systems to the second plurality of virtual circuits via the at least the second NNI. In one example, the at least one client system having the at least one virtual circuit that does not comply with the at least one constraint (e.g., the at least the second portion of the first plurality of client systems) may be assigned for a transfer to at least a third NNI (e.g., a new NNI where there is no VLAN collision for the client system and/or client virtual circuit to be transferred, where no PE rehoming will result, etc.). For example, step 360 may include the execution of instructions in accordance with the order generated at step 350. In one example, step 360 may include the processing system communicating with network elements via simple network management protocol (SNMP) instructions or the like to implement the selected configurations. Alternatively, or in addition, the processing system may provide the order/instructions to a software defined network (SDN) controller and/or a self-optimizing network (SON) orchestrator, or the like, which may then transmit instructions to network elements accordingly. In one example, step 360 may include obtaining confirmation from the second communication network that edge service provider network infrastructure is in place to support the second plurality of virtual circuits. In one example, step 360 may include obtaining confirmation from a network provisioning system that provider edge components of the first communication network are also in place to support the second plurality of virtual circuits.

At optional step 370, the processing system may disconnect the at least the first NNI. For instance, optional step 370 may comprise deactivating the first plurality of virtual circuits. In one example, optional step 370 may be in accordance with the set of instructions generated at step 350. Alternatively, or in addition, optional step 370 may include obtaining an indicator from network personnel that the second plurality of virtual circuits is in operation, and then deactivating the first plurality of virtual circuits in accordance with the set of instructions of step 360. In one example, step 370 may further include physical disconnection of the at least the first NNI, e.g., from respective line cards of a VPLS-PE network component and a corresponding edge component of the 3^{rd} party access network.

Following step 360 or optional step 370, the method 300 ends in step 395. It should be noted that method 300 may be expanded to include additional steps, or may be modified to replace steps with different steps, to combine steps, to omit steps, to perform steps in a different order, and so forth. For instance, in one example, the processing system may repeat one or more steps of the method 300, such as steps 310-360 or steps 310-370 for one or more subsequent days/nights (or other time period over which virtual circuit offloading/migration may be implemented), steps 320-360 for new high-bandwidth NNIs that may become available, and so forth. In one example, the method 300 may be repeated with respect to client virtual circuits associated with a third communication network (e.g., an additional 3^{rd} party access network that is different from the second communication network). Thus, for example, different provider/network constraints may be applicable in such an iteration of the method 300.

In one example, step 340 may include obtaining one or more additional input factors, such as an availability of network personnel, manually indicated priority factors (e.g., a network operator may designate a certain region or zone as a priority for offloading/migration, a certain 3^{rd} party access network, and so forth), client factors (e.g., a client has indicated a time period during which there should be no disruptions or potential disruptions to service), and so on. In one example, an additional factor may be based on a number of nearby NNIs that have already been offloaded (and in one example, scaled by a distance from an NNI under consideration for offloading). For instance, a network operator may prefer to offload within areas in which offloading has already commenced before proceeding to new areas/zones. As such, the priority of association may be scaled based on such factors and/or may be computed further based upon these additional inputs. In one example, the method 300 may be expanded or modified to include steps, functions, and/or operations, or other features described in connection with the example(s) of FIGS. 1 and 2, or as described elsewhere herein. Thus, these and other modifications are all contemplated within the scope of the present disclosure.

In addition, although not specifically specified, one or more steps, functions, or operations of the method 300 may include a storing, displaying, and/or outputting step as required for a particular application. In other words, any data, records, fields, and/or intermediate results discussed in the method 300 can be stored, displayed and/or outputted either on the device executing the method 300, or to another device, as required for a particular application. Furthermore, steps, blocks, functions, or operations in FIG. 3 that recite a determining operation or involve a decision do not necessarily require that both branches of the determining operation be practiced. In other words, one of the branches of the determining operation can be deemed as an optional step. In addition, one or more steps, blocks, functions, or operations of the above described method 300 may comprise optional steps, or can be combined, separated, and/or performed in a different order from that described above, without departing from the examples of the present disclosure.

FIG. 4 depicts a high-level block diagram of a computing device or processing system specifically programmed to perform the functions described herein. For example, any one or more components or devices illustrated in FIG. 1, or described in connection with the examples of FIGS. 2 and 3 may be implemented as the processing system 400. As depicted in FIG. 4, the processing system 400 comprises one or more hardware processor elements 402 (e.g., a microprocessor, a central processing unit (CPU) and the like), a memory 404, (e.g., random access memory (RAM), read only memory (ROM), a disk drive, an optical drive, a magnetic drive, and/or a Universal Serial Bus (USB) drive), a module 405 for transferring a first plurality of client systems associated with at least a first network-to-network interface and a first plurality of virtual circuits to a second plurality of virtual circuits via at least a second network-to-network interface, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in FIG. 4, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 4 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for transferring a first plurality of client systems associated with at least a first network-to-network interface and a first plurality of virtual circuits to a second plurality of virtual circuits via at least a second network-to-network interface (e.g., a software program comprising computer-executable instructions) can be loaded into memory 404 and executed by hardware processor element 402 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for transferring a first plurality of client systems associated with at least a first network-to-network interface and a first plurality of virtual circuits to a second plurality of virtual circuits via at least a second network-to-network interface (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
identifying, by a processing system including at least one processor deployed in a first communication network, a first plurality of virtual circuits and a first plurality of client systems associated with at least a first network-to-network interface between the first communication network and at least a second communication network, the at least the first network-to-network interface having a first bandwidth parameter;
selecting, by the processing system, at least a first portion of the first plurality of client systems for transfer from the first plurality of virtual circuits associated with the at least the first network-to-network interface to a second plurality of virtual circuits associated with at least a second network-to-network interface between the first communication network and the at least the second communication network, the at least the second network-to-network interface having a second bandwidth parameter;
generating, by the processing system, an order to establish the second plurality of virtual circuits via the at least the second network-to-network interface; and
transferring, by the processing system, the at least the first portion of the first plurality of client systems to the second plurality of virtual circuits via the at least the second network-to-network interface.

2. The method of claim 1, further comprising:
identifying an availability of the at least the second network-to-network interface.

3. The method of claim 2, further comprising:
selecting the at least the first network-to-network interface, in response to the identifying of the availability of the at least the second network-to-network interface.

4. The method of claim 2, wherein the identifying the availability of the at least the second network-to-network interface follows the identifying of the first plurality of virtual circuits and the first plurality of client systems.

5. The method of claim 1, further comprising:
selecting at least one of: the at least the first network-to-network interface or the at least the second network-to-network interface in accordance with at least a first constraint.

6. The method of claim 5, wherein the at least the first constraint comprises at least one of:
at least one network constraint;
at least one bandwidth constraint;
at least one virtual local area network tag constraint; or
at least one provider edge rehoming constraint.

7. The method of claim 6, wherein at least one of:
the at least one provider edge rehoming constraint comprises a constraint specifying that the at least the first network-to-network interface terminates on a same provider edge router as the at least the second network-to-network interface;
the at least one bandwidth constraint comprises a constraint specifying that the at least the second network-to-network interface has an available bandwidth that exceeds an aggregate bandwidth demand of the first plurality of virtual circuits;
the at least one network constraint comprises a constraint obtained from the at least the second communication network;
the at least one network constraint comprises a constraint specifying that the at least the second network-to-network interface does not service virtual circuits of different types;
the at least one virtual local area network tag constraint comprises a constraint that first virtual local area network tags associated with the first plurality of virtual circuits are unique with respect to second virtual local area network tags associated with a second plurality of virtual circuits assigned to the at least the second network-to-network interface; or
the at least one virtual local area network tag constraint comprises a constraint that virtual local area network tags of the first virtual local area network tags that are non-unique with respect to the second virtual local area network tags are for dual-tagged virtual circuits of the first plurality of virtual circuits.

8. The method of claim 5, wherein the selecting of the at least one of the at least the first network-to-network interface or the at least the second network-to-network interface in accordance with the at least the first constraint is based on a priority of association between the at least the first network-to-network interface and the at least the second network-to-network interface, wherein the priority of association is based on at least one of:
a number of managed information technology clients of the first plurality of client systems;
a number of tag collisions of the first plurality of virtual circuits on the second network-to-network interface;
a number of network-to-network interfaces of the at least the second network-to-network interface to be used to transfer the first plurality of virtual circuits; or
a number of virtual circuits of the first plurality of virtual circuits that are not able to be transferred off of the at least the first network-to-network interface without a provider edge rehoming.

9. The method of claim 1, wherein the generating comprises:
scheduling a migration of the at least the first portion of the first plurality of client systems to the second plurality of virtual circuits via the at least the second network-to-network interface.

10. The method of claim 1, wherein the transferring further comprises:
executing a set of instructions in accordance with the order.

11. The method of claim 1, further comprising:
disconnecting the at least the first network-to-network interface.

12. The method of claim 11, wherein the disconnecting comprises:
deactivating the first plurality of virtual circuits.

13. The method of claim 1, wherein the selecting the at least the first portion of the first plurality of client systems for transfer from the first plurality of virtual circuits to the second plurality of virtual circuits comprises:
identifying the at least the first portion as complying with at least one constraint.

14. The method of claim 13, wherein the at least one constraint comprises at least one of:
at least one network constraint;
at least one bandwidth constraint;
at least one virtual local area network tag constraint; or
at least one provider edge rehoming constraint.

15. The method of claim 14, wherein at least one of:
the at least one provider edge rehoming constraint comprises a constraint specifying that the at least the first network-to-network interface terminates on a same provider edge router as the at least the second network-to-network interface;
the at least one bandwidth constraint comprises a constraint specifying that the at least the second network-to-network interface has an available bandwidth that exceeds an aggregate bandwidth demand of the first plurality of virtual circuits;
the at least one network constraint comprises a constraint obtained from the at least the second communication network;
the at least one network constraint comprises a constraint specifying that the at least the second network-to-network interface does not service virtual circuits of different types;
the at least one virtual local area network tag constraint comprises a constraint that first virtual local area network tags associated with the first plurality of virtual circuits are unique with respect to second virtual local area network tags associated with a second plurality of virtual circuits assigned to the at least the second network-to-network interface; or
the at least one virtual local area network tag constraint comprises a constraint that virtual local area network tags of the first virtual local area network tags that are non-unique with respect to the second virtual local area network tags are for dual-tagged virtual circuits of the first plurality of virtual circuits.

16. The method of claim 13, wherein at least a second portion of the first plurality of clients systems comprises at least one client system having at least one virtual circuit of the first plurality of virtual circuits that does not comply with the at least one constraint.

17. The method of claim 16, wherein the at least one client system having the at least one virtual circuit that does not comply with the at least one constraint is assigned for a transfer to at least a third network-to-network interface.

18. The method of claim 1, wherein the at least the first network-to-network interface comprises a 1 gigabit interface, and wherein the at least the second network-to-network interface comprises a 10 gigabit interface.

19. A non-transitory computer-readable medium storing instructions which, when executed by a processing system including at least one processor when deployed in a first communication network, cause the processing system to perform operations, the operations comprising:
identifying a first plurality of virtual circuits and a first plurality of client systems associated with at least a first network-to-network interface between a first communication network and at least a second communication network, the at least the first network-to-network interface having a first bandwidth parameter;
selecting at least a first portion of the first plurality of client systems for transfer from the first plurality of virtual circuits associated with the at least the first network-to-network interface to a second plurality of virtual circuits associated with at least a second network-to-network interface between the first communication network and the at least the second communication network, the at least the second network-to-network interface having a second bandwidth parameter;
generating an order to establish the second plurality of virtual circuits via the at least the second network-to-network interface; and
transferring the at least the first portion of the first plurality of client systems to the second plurality of virtual circuits via the at least the second network-to-network interface.

20. An apparatus comprising:
a processing system including at least one processor; and
a computer-readable medium storing instructions which, when executed by the processing system when deployed in a first communication network, cause the processing system to perform operations, the operations comprising:
identifying a first plurality of virtual circuits and a first plurality of client systems associated with at least a first network-to-network interface between a first communication network and at least a second communication network, the at least the first network-to-network interface having a first bandwidth parameter;
selecting at least a first portion of the first plurality of client systems for transfer from the first plurality of virtual circuits associated with the at least the first network-to-network interface to a second plurality of virtual circuits associated with at least a second network-to-network interface between the first communication network and the at least the second communication network, the at least the second network-to-network interface having a second bandwidth parameter;
generating an order to establish the second plurality of virtual circuits via the at least the second network-to-network interface; and
transferring the at least the first portion of the first plurality of client systems to the second plurality of virtual circuits via the at least the second network-to-network interface.
